(19) United States
(12) Patent Application Publication
(10) Pub. No.: US 2016/0333865 A1
(43) Pub. Date: Nov. 17, 2016

(54) PROPELLANT ISOLATION BARRIER

(71) Applicant: Busek Co., Inc., Natick, MA (US)

(72) Inventors: Nathaniel Demmons, Mason, NH (US); Vladimir J. Hruby, Waban, MA (US); Douglas Spence, Seattle, WA (US)

(73) Assignee: Busek Co., Inc.

(21) Appl. No.: 15/093,937

(22) Filed: Apr. 8, 2016

Related U.S. Application Data
(63) Continuation-in-part of application No. 14/548,998, filed on Nov. 20, 2014.
(60) Provisional application No. 61/977,202, filed on Apr. 9, 2014.

(51) Int. Cl. F03H 1/00

(52) U.S. Cl. CPC F03H 1/0037

(57) ABSTRACT

An electrospray thruster and method includes an emitter, an extractor, and a propellant storage vessel. A porous propellant delivery pathway from the vessel to the emitter wicks liquid propellant to the emitter. An ionic liquid in the vessel has a chemical composition rending the ionic liquid solid at room temperature to prevent water absorption. In the liquid state, the ionic liquid exhibits favorable electrospray characteristics. A heater associated with the vessel is configured to heat the ionic liquid to above its melting point when thrust is required for delivery to the emitter via the porous propellant delivery pathway.

### RELATED APPLICATIONS

This application is a continuation-in-part of U.S. patent application Ser. No. 14/548,998 filed on Nov. 20, 2014 and claims the benefit of and priority thereto under 35 U.S.C. §§119, 120, 363, 365, and 37 C.F.R. §1.55 and §1.78. application Ser. No. 14/548,998 claims benefit of and priority to U.S. Provisional Application Ser. No. 61/977,202, filed on Apr. 9, 2014 under 35 U.S.C. §§119, 120, 363, 365, and 37 C.F.R. §1.55 and §1.78 All said priority references are incorporated herein by this reference.

### FIELD OF THE INVENTION

This invention relates to an electrospray device.

### BACKGROUND OF THE INVENTION

Electrospray thrusters can operate by generating and expelling charged droplets or ions from a conductive liquid that are accelerated through an electrostatic field. Electrospray thrusters typically use ionic liquids as a propellant. Ionic liquids are ideal in that they have negligible vapor pressure and do not evaporate when exposed to high vacuum conditions. However, conventional ionic liquids used as propellant in electrospray thrusters can absorb contaminants at atmospheric conditions, such as water vapor, atmospheric gases, particles, and the like, that can detrimentally affect the performance of the electrospray thruster. Thus, electrospray thrusters may require propellant isolation systems at atmospheric conditions, such as valves or other similar type devices, to protect the ionic liquid propellant in the propellant storage vessel.

When passive propellant delivery systems are used, typically including a porous metal emitter, the ionic liquid proceeds to the emitter from the storage vessel via capillary action. See U.S. Pat. Nos. 7,932,492 and 8,324,593 incorporated herein by this reference. A valve to isolate the storage vessel may not be possible.

### BRIEF SUMMARY OF THE INVENTION

Featured is an electrospray thruster comprising an emitter, an extractor, and a propellant storage vessel. A porous propellant delivery pathway from the vessel to the emitter is for wicking liquid propellant to the emitter. An ionic liquid in the vessel has a chemical composition rending the ionic liquid solid at room temperature to prevent water absorption and, in a liquid state, exhibits favorable electrospray characteristics. A heater associated with the vessel is configured to heat the ionic liquid to above its melting point for delivery to the emitter via the porous propellant delivery pathway.

In one example, the favorable electrospray emission characteristics include electrical conductivity, surface tension, and viscosity. Room temperature may be defined as approximately 20-50° C. The melting point of the ionic liquid may be above 60° C.

In one example, the ionic liquid chemical composition includes an anion having known favorable electrospray electrochemical characteristics and a cation which, when combined with the anion, renders the ionic liquid solid at room temperature. Examples of ionic liquids meeting those requirements include tetrabutylammonium bis-trifluoromethanesulfonimate; tetrapentylammonium rhodanide; tetrabutylammonium rhodanide; 1-methyl-3-(1H,1H,2H,2H-perfluorooctyl)imidazolium hexafluorophosphate; 1-methyl-3-benzylimidazolium tetrafuoroborate; tetrabutylammonium tetrafluoroborate; and 1-Benzyl-3-methylimidazolium Hexafluorophosphate.

The thruster may further include a controller configured to energize the heater to melt the ionic liquid and thereafter to apply a voltage potential between the storage vessel and the extractor to create a Taylor cone at the electrospray emitter.

Also featured is a method of generating thrust comprising storing in a propellant storage vessel an ionic liquid in solid form at room temperature, heating the ionic liquid above its melting point, wicking the melted ionic liquid to an emitter positioned proximate an extractor, and generating a voltage potential to create an electrospray producing thrust.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a schematic view showing one embodiment of the propellant isolation barrier of this invention;

FIG. 2 is a schematic view showing the isolation barrier shown in FIG. 1 in the liquid phase and mixed with the primary propellant;

FIG. 3 is s a schematic view showing another embodiment of a electrospray device in accordance with an example of the invention with the propellant in a solid phase; and

FIG. 4 is a schematic view showing the electrospray device of FIG. 3 with the propellant in a liquid phase.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

As discussed in the Background section above, electrospray thrusters often use ionic liquids as a propellant because they have negligible vapor pressure and do not evaporate when exposed to vacuum conditions. Some conventional ionic liquid propellants use by electrospray thrusters include 1-ethyl-3-methylimidazolium bis(trifluoromethylsulfonyl)imide (EMI-Im), 1-ethyl-3-methylimidazolium tetrafluoroborate, (EMI-BF4), 1-butyl-3-methylimidazolium hexafluorophosphate ([bmim][PF(6)]), 1-ethyl-3-methylimidazolium thiocyanate, and the like, However, when conventional ionic liquids are used as propellant in electrospray thrusters, they can absorb contaminants at atmospheric conditions which can detrimentally affect the performance of the electrode spray thruster. Thus, electrospray thrusters rely on cumbersome propellant isolation systems, such as valves and the like, to protect the ionic liquid propellant in the storage vessel. Such propellant isolation systems can fail and incur additional expense.

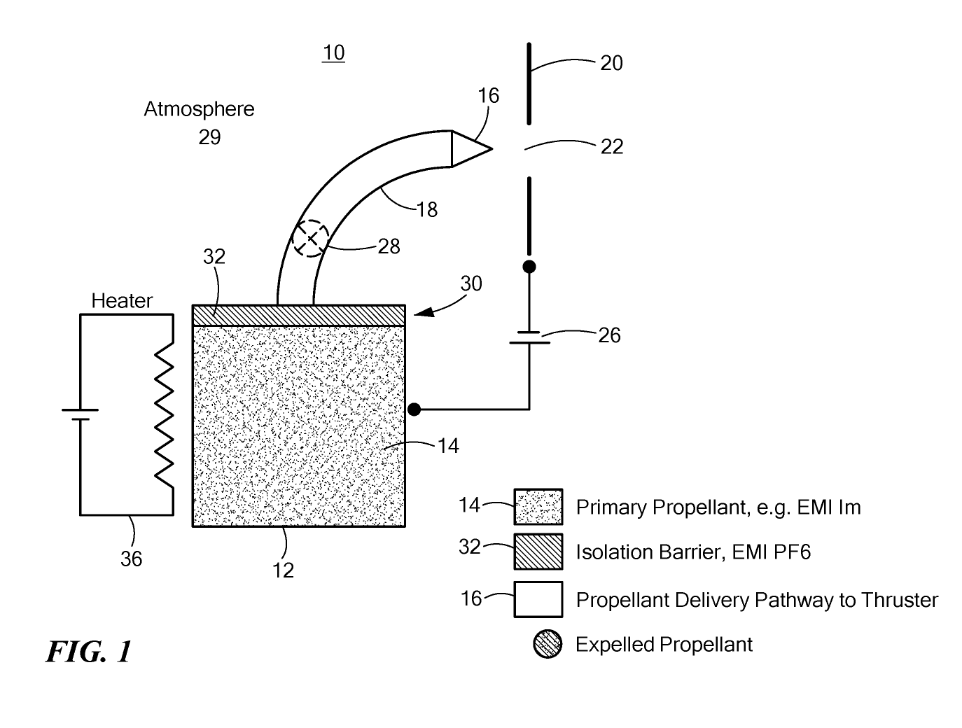

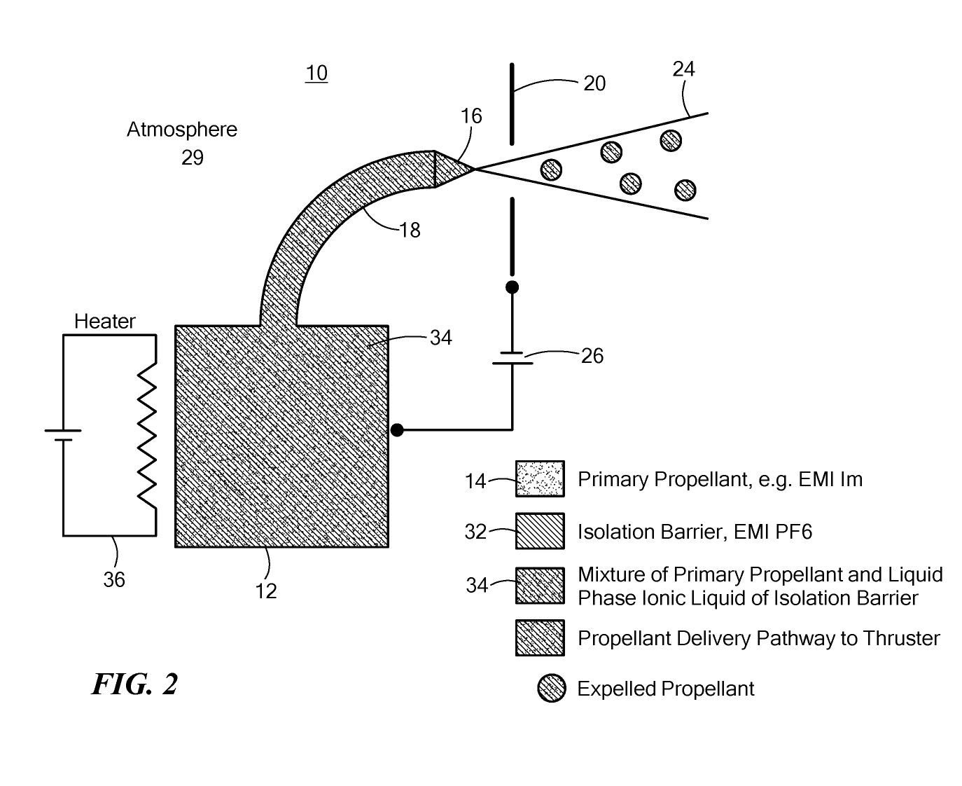

There is shown in FIG. 1 a typical electrospray thruster 10 that includes storage vessel 12 which stores primary conventional ionic liquid propellant 14 as discussed above. Electrospray thruster 10 also includes emitter 16 coupled to propellant delivery pathway 18 which is adapted to receive propellant 14. Electrospray thruster 10 also includes extraction grid 20 with aperture 22 through which electrospray 24, FIG. 2, is formed and expelled. Power supply 26, FIG. 1, e.g., a battery or similar type power supply, is connected across extraction plate 20 and storage vessel 12 to create a voltage potential difference to create electrospray 24 to create thrust.

Electrospray thruster 10 typically relies on some type of propellant isolation system, e.g., propellant isolation system 28 (shown in phantom), such as a valve or similar type device, to protect ionic liquid propellant 14 from absorbing contaminants from atmosphere 29.

Propellant isolation barrier 30 of one embodiment of this invention includes ionic liquid 32 configured to have a solid phase at temperatures less than a predetermined temperature, e.g., about 60° C., and a liquid phase at temperatures greater than the predetermined temperature, e.g., 60° C. Ionic liquid 32 is configured to create propellant isolation barrier 30, FIG. 1, when in the solid phase (as shown) at atmospheric conditions and mix with primary propellant 14, as shown by mixture 34, FIG. 2, where like parts have been given like numbers, in the liquid phase, and remain in the liquid phase and miscible with primary liquid propellant 14 at the temperatures greater or less than the predetermined temperature when mixed with primary propellant 14 to create electrospray 20 to create thrust. Thus, after ionic liquid 32, FIG. 1, in the solid form has melted mixed with primary propellant 14 as shown by mixture 34, FIG. 2, ionic liquid 32 remains in the liquid phase over the operating temperature of primary propellant 14 of electrospray thruster, e.g., about 20° C.

In one design, heater 36 may be used to heat ionic liquid 32 of propellant isolation barrier 30 to change it from the solid phase as shown in FIG. 1 to the liquid phase as shown in FIG. 2.

The result is isolation barrier 30, FIG. 1, prevents the absorption of water vapor, atmospheric gases, particles, and the like, by primary propellant 14 from atmosphere 29 at atmospheric conditions without requiring propellant isolation subsystem, e.g., propellant isolation subsystem. Isolation barrier 30 also prevents wetting of the wicking based feed subsystem of electrospray thruster 10 comprised of emitter 16 and propellant delivery pathway 18 by primary liquid propellant to ensure proper filling of a propellant storage vessel 12 under the operation environment of the electrospray thruster, e.g., vacuum condition of outer space. Additionally, isolation barrier 30 may be used as a secondary liquid propellant for electrospray thruster 10 as shown by mixture 34, FIG. 2 to create thrust when operational.

In one example, ionic liquid 32 of propellant isolation barrier 30 is preferably a hydrophobic ionic liquid having a melting temperature greater than the melting temperature of primary propellant 14. In one example, ionic liquid 32 may be 1-ethyl-3-methylimidazolium hexafluorophosphate (EMI PF6). In other examples, ionic liquid 32 may be 1-methyl-3-(3,3, . . . -tridecafluoroctyl) imidazolium hexafluophosphate or tetrabutyl-ammonium bis (trifluoromethylsulfonyl) imide, or similar type ionic liquids.

Ionic liquid 32 is unique in that is it is relatively hydrophobic ionic liquid that can be stored for extended periods of time on the ground or on station, in solid form without propellant contamination or degradation.

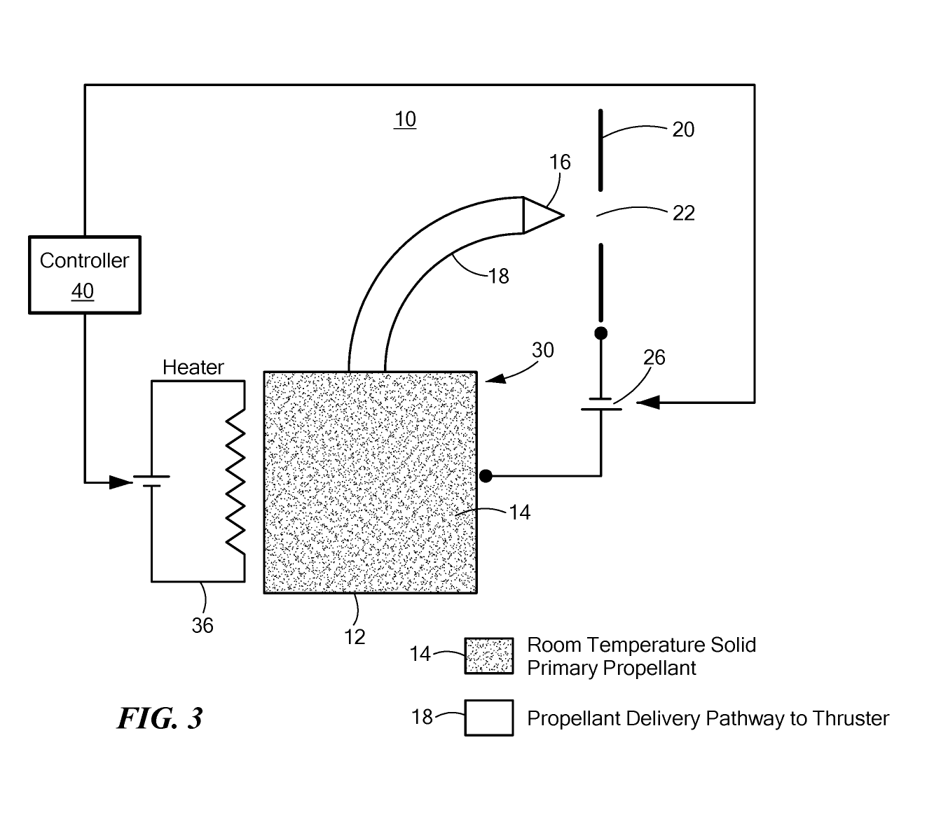

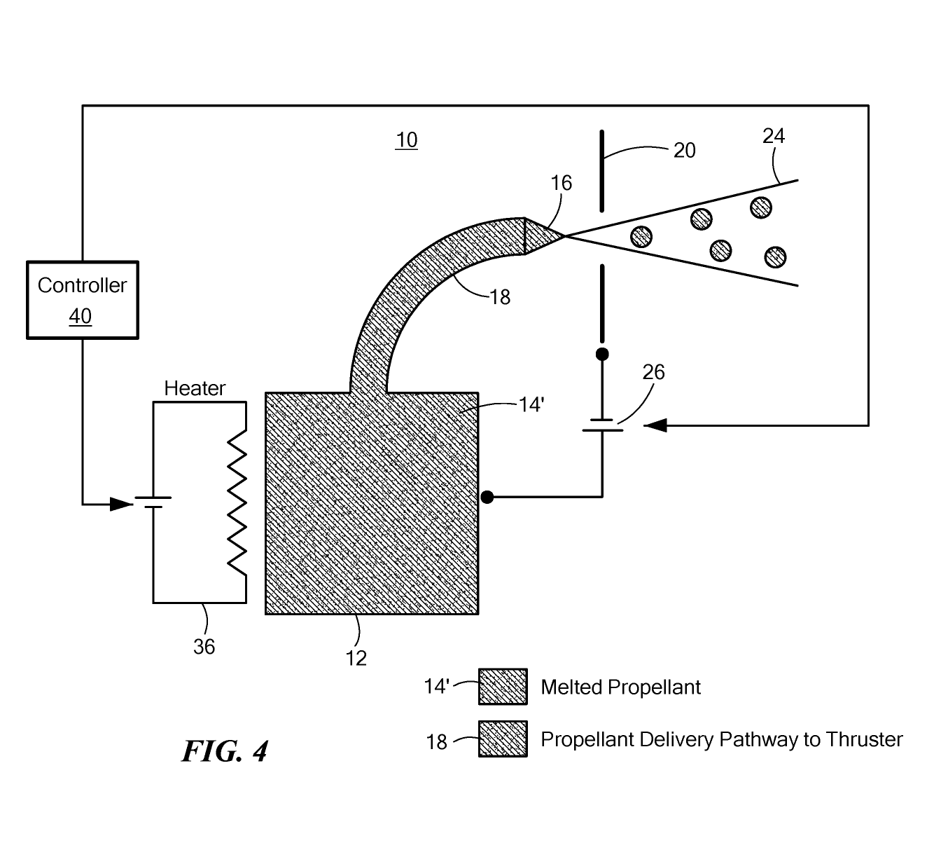

In FIGS. 1-2, the ionic liquid of the isolation barrier typically comprises only a fraction of the contents of the vessel 12 as the ionic liquid does not generally have favorable electrospray characteristics. In the embodiments of FIGS. 3-4, the ionic liquid barrier typically fills the vessel and may constitute the only contents of the vessel. In such embodiments, the ionic liquid chosen is the solid phase at room temperature and exhibits favorable electrospray characteristics in the liquid phase.

Electrospray device 10, FIGS. 3-4 (typically employed as a spacecraft thruster) includes emitter 16, extractor 20 with opening 22, and propellant storage vessel 12. The system is passive in that there is a porous propellant delivery pathway 18 from vessel 12 to emitter 16 for wicking liquid propellant to the emitter by capillary action. The emitter/extractor subsystem may be in needle form, linear, or annular.

Ionic liquid 14 in vessel 12 has a chemical composition rending the ionic liquid in the solid phase at room temperature (e.g., 20-50° C.) to prevent water absorption. Still, ionic liquid 14 in the liquid phase has a chemical composition with favorable electrospray emission characteristics (e.g., electrical conductivity greater than 0.5 s/m), surface tension, and viscosity). Testing the properties of various ionic liquids which are suitable may be conducted in accordance with the techniques disclosed in Legge, Jr. and Lazano, “Performance of Heavy Ionic Liquids with Porous Metal Electrospray Emitters,” American Institute of Aeronautics and Astronautics, 44^{th} AIAA/ASME/SAE/ASEE Joint Compulsion Conference and Exhibit, July 2008 (AIAA-2008/5002) incorporated herein by this reference.

Heater 36 is associated with vessel 12, and, when energized, typically under the control of controller 40, raises the temperature of the ionic liquid to above its melting point (e.g., 90-95° C.). Power supply 26, for example a battery or similar type power supply, is connected across extraction plate 20 and storage vessel 12 to create a voltage potential difference to create Taylor cone 24 at extractor 20 to create thrust using the now liquid ionic fluid.

When thrust is required, to maneuver or reposition a spacecraft in space, for example, controller 40 is programmed to control heater 36 turning it on. Before that, propellant 14 is in the solid phase to prevent water absorption from the environment through delivery pathway 18 to vessel 12.

Once heater 36 reaches a sufficient temperature and melts propellant 14, controller 40 controls power supply 26 to turn on and an electrospray Taylor cone 24, FIG. 2 is created as the now liquid propellant, by capillary action, feeds emitter 16 by a wicking action.

The preferred ionic liquid propellant chemical composition includes an anion having known favorable electrospray emission characteristics and a cation which, when combined, with the anion, renders the ionic liquid solid at room temperature. A high electrical conductivity and high surface tension are preferred when the ionic liquid is at temperature above the melting temperature. The anion of the chosen ionic liquid has favorable electrochemistry characteristics when used in electrospray systems.

In one example, the propellant was Tetrabutylammonium bis-trifluoromethanesulfonimate. See the Sigma-Aldrich Safety Data Sheet, Version 3.4 (Jun. 26, 2014) incorporated herein by this reference.

Other ionic liquids where are solid at room temperature, which melt fairly quickly at a temperature which can be reached by heater 36, and which exhibit favorable electrospray emission characteristics include tetrapentylammonium rhodanide, tetrabutylammonium rhodanide, 1-methyl-3-(1H,1H,2H,2H-perfluorooctyl)imidazolium hexafluorophosphate, 1-methyl-3-benzylimidazolium tetrafuoroborate, tetrabutylammonium tetrafluoroborate, and 1-Benzyl-3-methylimidazolium Hexafluorophosphate. Other ionic liquids which are solid at room temperature and which exhibit favorable electrospray characteristics maybe used.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

What is claimed is:

1. An electrospray thruster comprising:
an emitter;
an extractor;
a propellant storage vessel;
a porous propellant delivery pathway from the vessel to the emitter for wicking liquid propellant to the emitter;
an ionic liquid in the vessel having a chemical composition rending the ionic liquid solid at room temperature to prevent water absorption and, in a liquid state, exhibiting favorable electrospray characteristics; and
a heater associated with the vessel and configured to heat the ionic liquid to above its melting point for delivery to the emitter via the porous propellant delivery pathway.

2. The thruster of claim 1 in which said favorable electrospray emission characteristics include electrical conductivity, surface tension, and viscosity.

3. The thruster of claim 1 in which room temperature is approximately 20-50° C.

4. The thruster of claim 1 in which said melting point is above 60° C.

5. The thruster of claim 1 in which the ionic liquid chemical composition includes an anion having known favorable electrospray electrochemistry characteristics and a cation which, when combined with the anion, renders the ionic liquid solid at room temperature.

6. The thruster of claim 1 in which said ionic liquid is selected from the group including: tetrabutylammonium bis-trifluoromethanesulfonimate; tetrapentylammonium rhodanide; tetrabutylammonium rhodanide; 1-methyl-3-(1H,1H,2H,2H-perfluorooctyl)imidazolium hexafluorophosphate; 1-methyl-3-benzylimidazolium tetrafuoroborate; tetrabutylammonium tetrafluoroborate; and 1-Benzyl-3-methylimidazolium Hexafluorophosphate.

7. The thruster of claim 1 further including a controller configured to energize the heater to melt the ionic liquid and thereafter to apply a voltage potential between the storage vessel and the extractor to create a Taylor cone at the emitter.

8. A method of generating thrust comprising:
storing in a propellant storage vessel an ionic liquid in solid form at room temperature;
heating the ionic liquid above its melting point;
wicking the melted ionic liquid to an emitter positioned proximate an extractor; and
generating a voltage potential to create an electrospray producing thrust.

9. The method of claim 8 in which ionic liquid has favorable electrospray emission characteristics include electrical conductivity, surface tension, and viscosity.

10. The method of claim 8 in which room temperature is approximately 20-50° C.

11. The method of claim 8 in which said melting point is above 60° C.

12. The method of claim 8 in which the ionic liquid chemical composition includes an anion having known favorable electrospray electrochemistry characteristics and a cation which, when combined with the anion, renders the ionic liquid solid at room temperature.

13. The method of claim 8 in which said ionic liquid is selected from the group including: tetrabutylammonium bis-trifluoromethanesulfonimate; tetrapentylammonium rhodanide; tetrabutylammonium rhodanide; 1-methyl-3-(1H,1H,2H,2H-perfluorooctyl)imidazolium hexafluorophosphate; 1-methyl-3-benzylimidazolium tetrafuoroborate; tetrabutylammonium tetrafluoroborate; and 1-Benzyl-3-methylimidazolium Hexafluorophosphate.
